(19) United States
(12) Patent Application Publication
(10) Pub. No.: US 2023/0011782 A1
(43) Pub. Date: Jan. 12, 2023

(54) LINK ASSEMBLY FOR AN AERIAL LIFT ASSEMBLY

(71) Applicant: Terex South Dakota, Inc., Watertown, SD (US)

(72) Inventors: Adam HAILEY, Kirkland, WA (US); Blake BUCHANAN, Watertown, SD (US)

(21) Appl. No.: 17/369,404

(22) Filed: Jul. 7, 2021

(51) Int. Cl. B66F 11/04

(52) U.S. Cl. CPC B66F 11/046; B66F 11/042

(57) ABSTRACT

An aerial lift assembly is provided with a base to support the aerial lift assembly upon an underlying support surface. A first link assembly is pivotally connected to the base to pivotally expand and collapse from the base. A first extendable boom assembly is pivotally connected to the first link assembly to pivotally expand and collapse from the first link assembly, and to extend and retract from the first link assembly. A first actuator is in cooperation with the first extendable boom assembly to extend and retract the first extendable boom assembly. A second extendable boom assembly is pivotally connected to the first extendable boom assembly to pivotally expand and collapse from the first extendable boom assembly, and to extend and retract from the first extendable boom assembly. An operator platform is supported by the second extendable boom assembly.

### TECHNICAL FIELD

Various embodiments relate to link assemblies for aerial lift assemblies.

### BACKGROUND

Aerial lift assemblies provide an operator platform on a link assembly that pivots and/or translates to lift the operator platform to an elevated worksite.

### SUMMARY

According to at least one embodiment, an aerial lift assembly is provided with a base to support the aerial lift assembly upon a support surface. A first link assembly is pivotally connected to the base to pivotally expand and collapse from the base. A second link assembly is pivotally connected to the first link assembly to pivotally expand and collapse from the first link assembly. A first extendable boom assembly is pivotally connected to the second link assembly to pivotally expand and collapse from the second link assembly, and to extend and retract from the second link assembly. An operator platform is supported by the first extendable boom assembly.

According to a further embodiment, the second link assembly includes a second extendable boom assembly pivotally connected to the first link assembly to pivotally expand and collapse from the first link assembly, and to extend and retract from the first link assembly.

According to an even further embodiment, a first actuator is in cooperation with the second extendable boom assembly to extend and retract the second extendable boom assembly. A controller is in communication with the first actuator. The controller is programmed to limit extension of the second extendable boom assembly when the first link assembly is collapsed.

According to an even further embodiment, the controller is further programmed to limit extension of the second extendable boom assembly when the first link assembly is not expanded.

According to an even further embodiment, the controller is further programmed to permit extension of the second extendable boom assembly when the first link assembly is in an expanded position.

According to another even further embodiment, a second actuator is in cooperation with the second link assembly to expand and collapse the first link assembly. The controller is in communication with the second actuator and is further programmed to expand the first link assembly prior to extending the second extendable boom assembly.

According to another further embodiment, a frame is to be supported upon an underlying support surface. The base is pivotally connected to the frame about an axis that is generally upright relative to the underlying support surface.

According to an even further embodiment, the first link assembly is pivotally connected to the base about an axis that is generally perpendicular to the pivot axis of the base. The first link assembly pivot axis is offset from the base pivot axis such that the first link assembly converges toward the base pivot axis in a collapsed position of the first link assembly and the first link assembly is pivoted away from the base pivot axis in an expanded position of the first link assembly.

According to an even further embodiment, a counterbalance is supported upon the base spaced apart from the base pivot axis. The first link assembly pivot axis is oriented between the counterbalance and the base pivot axis.

According to an even further embodiment, the first link assembly pivots away from the counterbalance toward the collapsed position.

According to an even further embodiment, the second link assembly pivots toward the counterbalance in the collapsed position.

According to another further embodiment, a third link assembly is pivotally connected to the first extendable boom assembly. The operator platform is connected to the third link assembly and spaced apart from the first extendable boom assembly.

According to another further embodiment, the first link assembly includes a compression link pivotally connected to the base. A tension link is pivotally connected to the base spaced apart from the pivotal connection of the compression link and the base. An intermediate link is pivotally connected to the compression link, the tension link and the second link assembly.

According to an even further embodiment, the second link assembly includes a second compression link pivotally connected to the intermediate link. A timing link is pivotally connected to the first compression link and the second compression link. A linear actuator is pivotally connected to the intermediate link and the second compression link.

According to another embodiment, an aerial lift assembly is provided with a base to support the aerial lift assembly upon a support surface. A first link assembly is pivotally connected to the base to pivotally expand and collapse from the base. A first extendable boom assembly is pivotally connected to the first link assembly to pivotally expand and collapse from the first link assembly, and to extend and retract from the first link assembly. A first actuator is in cooperation with the first extendable boom assembly to extend and retract the first extendable boom assembly. A second extendable boom assembly is pivotally connected to the first extendable boom assembly to pivotally expand and collapse from the first extendable boom assembly, and to extend and retract from the first extendable boom assembly. An operator platform is supported by the second extendable boom assembly. A controller is in communication with the first actuator. The controller is programmed to limit extension of the first extendable boom assembly when the first link assembly is collapsed.

According to a further embodiment, the controller is further programmed to limit extension of the first extendable boom assembly when the first link assembly is not expanded.

According to an even further embodiment, the controller is further programmed to permit extension of the first extendable boom assembly when the first link assembly is in an expanded position.

According to another further embodiment, a second actuator is in cooperation with the first link assembly to expand and collapse the first link assembly. The controller is in communication with the second actuator and is further programmed to expand the first link assembly prior to extending the first extendable boom assembly.

According to another embodiment, an aerial lift assembly is provided with a frame to be supported upon an underlying support surface. A base is pivotally connected to the frame about an axis that is generally upright relative to the underlying support surface. A first link assembly is pivotally connected to the base about an axis that is generally perpendicular to the pivot axis of the base to pivotally expand and collapse from the base. The first link assembly pivot axis is offset from the base pivot axis such that the first link assembly converges toward the base pivot axis in a collapsed position of the first link assembly and the first link assembly is pivoted away from the base pivot axis in an expanded position of the first link assembly. A counterbalance is supported upon the base spaced apart from the base pivot axis. The first link assembly pivot axis is oriented between the counterbalance and the base pivot axis. The first link assembly pivots away from the counterbalance toward the collapsed position. A first actuator is in cooperation with the second link assembly to expand and collapse the first link assembly. A first extendable boom assembly is pivotally connected to the first link assembly to pivotally expand and collapse from the first link assembly, and to extend and retract from the first link assembly. The first extendable boom assembly pivots toward the counterbalance in the collapsed position. A second actuator is in cooperation with the first extendable boom assembly to extend and retract the first extendable boom assembly. A second extendable boom assembly is pivotally connected to the first extendable boom assembly to pivotally expand and collapse from the first extendable boom assembly, and to extend and retract from the first extendable boom assembly. A second link assembly is pivotally connected to the second extendable boom assembly. An operator platform is supported by the second link assembly to be spaced apart from the second extendable boom assembly. A controller is in communication with the first actuator and the second actuator. The controller is programmed to expand the first link assembly prior to extending the first extendable boom assembly. Extension of the first extendable boom assembly is limited when the first link assembly is not expanded. Extension of the first extendable boom assembly is permitted when the first link assembly is in the expanded position.

According to a further embodiment, the first link assembly is provided with a first compression link pivotally connected to the base. A tension link is pivotally connected to the base spaced apart from the pivotal connection of the compression link and the base. An intermediate link is pivotally connected to the compression link, the tension link and the first extendable boom assembly. The first extendable boom assembly further includes a second compression link pivotally connected to the intermediate link. A timing link is pivotally connected to the first compression link and the second compression link. The actuator further includes a linear actuator pivotally connected to the intermediate link and the second compression link.

### BRIEF DESCRIPTION OF THE DRAWINGS

FIG. 1 is a side elevation view of an aerial lift assembly according to an embodiment, illustrated in a collapsed position;

FIG. 2 is another side elevation view of the aerial lift assembly of FIG. 1, illustrated in an intermediate position;

FIG. 3 is another side elevation view of the aerial lift assembly of FIG. 1, illustrated in another intermediate position;

FIG. 4 is another side elevation view of the aerial lift assembly of FIG. 1, illustrated in an expanded position; and

FIG. 5 is a side elevation view of a reach envelope of the aerial lift assembly of FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Aerial lift assemblies provide an operator platform on an armature that pivots and/or translates to lift the operator platform to an elevated worksite. Conventional aerial lift assemblies include various adjustable structures to lift an operator platform to a height for performing a work operation. The aerial lift assemblies often include an articulated boom assembly, which may be provided by a four-bar linkage mechanism or an extending riser type linkage. The four-bar linkage mechanism may employ at least four links, with at least four movable connections, such as four pivotal connections, or three pivotal connections with one translation connection. The extending riser type linkage may include a linearly extendable arm that is also pivotal.

A foot print of an aerial lift assembly is a primary factor of aerial lift assemblies. Another factor is a working envelope of the aerial lift assembly. A counterweight is often utilized to balance the armature and to maintain a center of gravity of the aerial lift assembly. Another aerial lift assembly employs a boom with an extension tube, that is pivoted upon a four-bar linkage with a counterweight for balance and stability.

By managing a center of gravity of an aerial lift assembly through linkage and structure design, the counterweight can be optimized, and the footprint can be optimized to provide operation performance with an enlarged range of motion of substantial lifting capacity without requiring an oversized counterweight or footprint. When collapsed, an aerial lift assembly is often transported by a truck and therefore, the overall weight and footprint are sized and designed to facilitate towing and transportation of the aerial lift assembly.

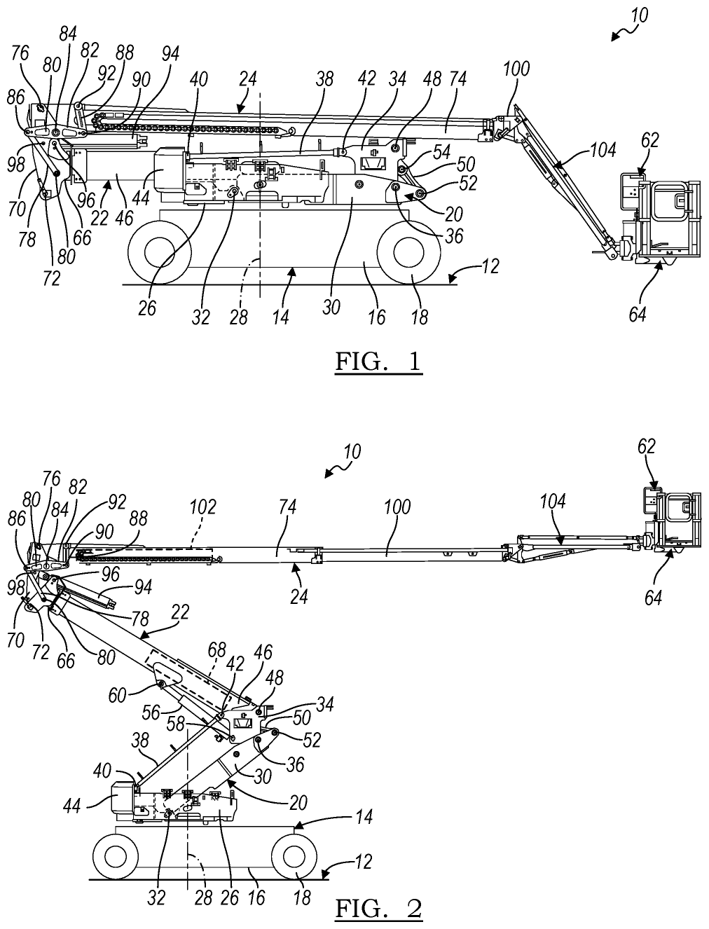

FIGS. 1-4 illustrate an aerial lift assembly 10 according to an embodiment. The aerial lift assembly 10 is a mobile aerial lift assembly 10, which is collapsible for transportation upon an underlying support surface 12, such as the ground or a floor. The aerial lift assembly 10 is also transportable for towing and transport upon a trailer behind a truck. The aerial lift assembly 10 is expandable by operator control to lift an operator to an elevated worksite. The aerial lift assembly 10 is discussed with relation to the ground 12. Therefore, terms such as upper, lower, and other height related terms are relative to height from the ground 12 are not to limit the aerial lift assembly 10 to ground 12 specific applications. Additionally, terms such as first and second are utilized in order of introduction and are not limiting an order of sequence or arrangement of components. Likewise, terms such as primary and secondary may also have meaning within the art, such as an order of introduction and do not connote any structural or sequential meaning to these components.

The aerial lift assembly 10 includes a lift structure that provides significant stability and performance characteristics by maintaining a center of gravity of the aerial lift assembly 10 in an advantageous position for stability. The aerial lift assembly 10 includes a frame 14, illustrated schematically in FIGS. 1 and 2 to support the aerial lift assembly 10 upon the ground 12 or any support surface. The frame 14 includes a chassis 16, which is supported upon a plurality of wheels 18 that contact the ground 12.

The aerial lift assembly 10 includes a lower secondary articulation assembly 20, with an upper secondary extension structure assembly 22, and a further primary extension structure assembly 24. These upper and lower structural articulation assemblies 20, 22, maximize the range of motion and performance of the aerial lift assembly 10 in a compact arrangement. The upper and lower structural articulation assemblies 20, 22 work in cooperation with the primary extension structure assembly 24 to manage the center of gravity of the aerial lift assembly 10 to maximize stability while minimizing a counterweight and a footprint of the aerial lift assembly 10.

The aerial lift assembly 10 includes a base 26 pivotally connected to the frame about a generally upright axis 28. The base 26 is illustrated partially disassembled to reveal the underlying structural components. The pivotal axis 28 is designed to be near vertical within an acceptable angular tolerance, such as plus or minus ten degrees. Of course, the upright angle of the axis 28 depends upon the flatness of the underlying support surface 12.

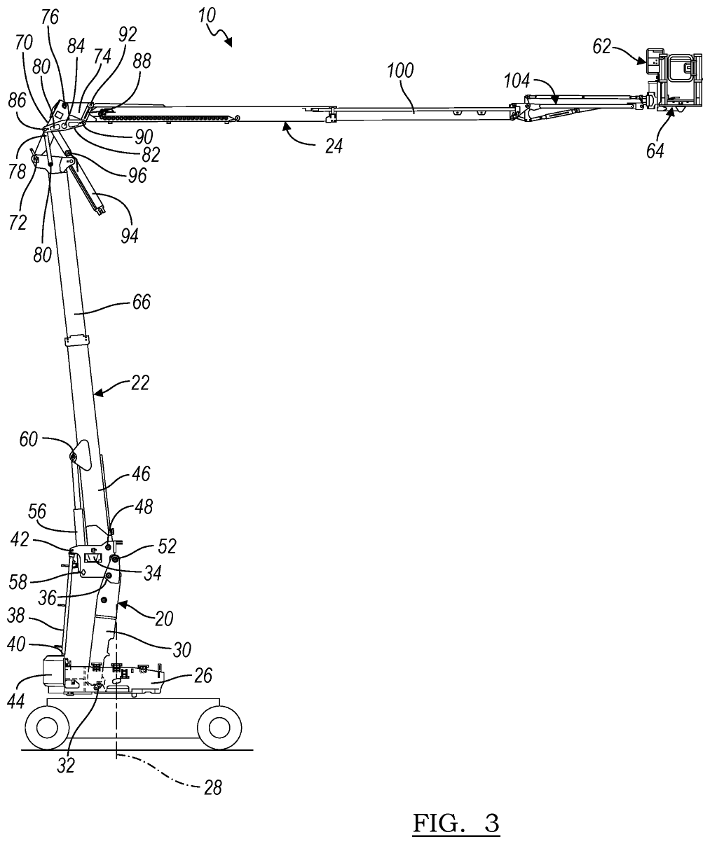

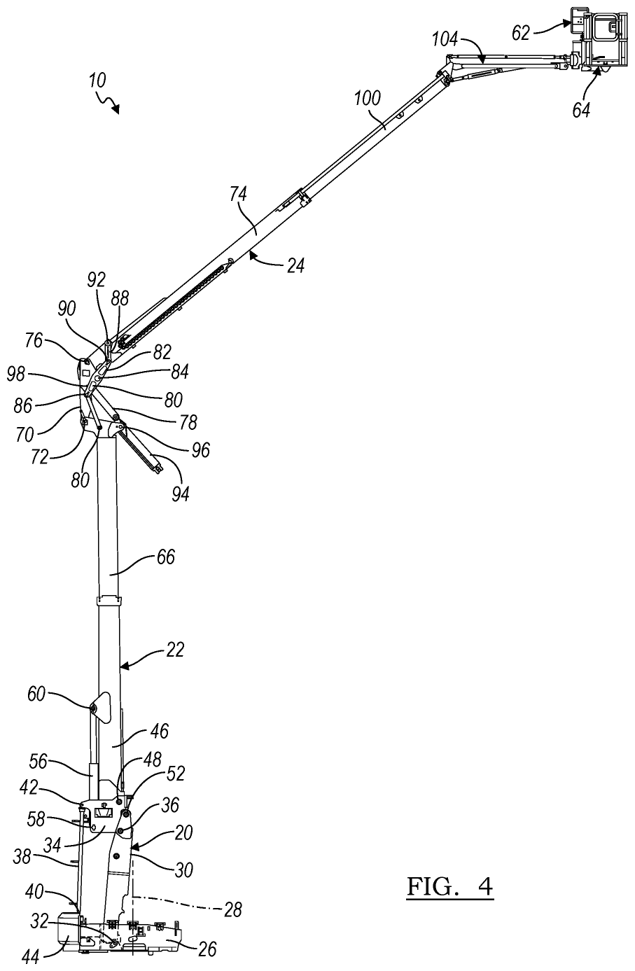

The lower secondary articulation assembly 20 is a first link assembly 20 of the aerial lift assembly 10. A compression link 30 is pivotally connected to the base 26 at a proximal end of the compression link 30 at a pivotal connection 32. The pivotal connection 32 is generally perpendicular to the base pivot axis 28. In other words, the pivotal connection 32 is designed to be perpendicular to the base pivot axis 28 within an acceptable tolerance, such as plus or minus ten degrees. The compression link 30 is illustrated in a collapsed position in FIG. 1, which is horizontal along the length of the link 30. The compression link 30 is pivotal past intermediate positions of FIGS. 2 and 3 to an upright position, which is almost vertical, of FIG. 4.

A mid pivot link 34 is an intermediate link that is pivotally connected to the compression link 30 at a distal end of the compression link 30 at a pivotal connection 36, which is designed to be parallel with the compression link proximal pivotal connection 32. A tension link 38 is also provided with a pivotal connection 40 at a proximal end with the base 26 and a pivotal connection 42 at a distal end with the mid pivot link 34. The tension link 38 is under tension, while the compression link 30 is under compression due to applicable loading upon the lower secondary articulation assembly 20. The length of the tension link 38 matches the length of the compression link 30. Likewise, the proximal pivotal connections 32, 40 of the links 30, 38 with the base 26 are spaced apart to match the spacing of the distal pivotal connections 36, 42 with the mid pivot link 34 to form a parallelogram. This parallelogram arrangement of the lower secondary articulation assembly 20 provides a four-bar mechanism with the base 26, compression link 30, mid pivot link 34 and the tension link 38 to expand and collapse relative to the base 26.

100381 The base 26 supports a counterbalance 44 that is provided spaced apart from the base pivot axis 28. The counterbalance 44 is utilized to offset and balance a center of gravity of the aerial lift assembly 10. To assist with controlling the location of the center of gravity, the pivotal connections 32, 40 of the lower secondary articulation assembly 20 are provided between the base pivot axis 28 and the counterbalance 44. In the collapsed position in FIG. 1 of the lower articulation assembly 20, the compression link 30 and the tension link 38 extend along the base 26 and converge towards the base pivot axis 28. However, in the expanded position of FIG. 4, the compression link 30 and the tension link 38 are pivoted away from the base pivot axis 28 and are oriented spaced apart from the base pivot axis 28 toward the counterbalance 44.

The upper secondary extension structure assembly 22 is a second link assembly that includes an outer boom tube 46 with a proximal end pivotally connected to the mid pivot link 34 at a pivotal connection 48. The outer boom tube 46 acts a compression link and is collapsed toward the compression link 30 and the counterbalance 44 in the collapsed position of FIG. 1. The outer boom tube 46 expands away from the compression link 30 as the upper secondary extension structure assembly 22 expands, as illustrated in FIGS. 2-4.

A timing link 50 has a proximal end pivotally connected to the compression link 30 at pivotal connection 52 and a distal end pivotally connected to the outer boom tube 46 at pivotal connection 54 (FIG. 1). The timing link 50 ties the pivoting of the outer boom tube 46, in expansion and retraction to that of the compression link 30. In other words, the timing link 50 maintains an angle of inclination of the outer boom tube 46 relative to horizontal to an angle of inclination of the compression link 30. By coordinating the angles of inclination of the compression link 30 and the outer boom tube 46, the center of gravity of the lower secondary articulation assembly 20 and the upper secondary extension assembly 22 can be regulated and maintained.

The upper secondary extension assembly 22 includes a linear actuator 56 with a proximal end pivotally connected to the mid pivot link 34 at a pivotal connection 58 and a distal end pivotally connected to the outer boom tube 46 at a pivotal connection 60. The linear actuator 56 can be any suitable linear actuator, such as a hydraulic cylinder, which is controlled by a controller 62 on an operator platform 64 supported by the primary extension assembly 24. The controller 62 can be located anywhere accessible by a display upon the aerial lift assembly 10 or remotely and, perhaps even wirelessly.

Extension of the linear actuator 56 causes the outer boom tube 46 to pivot relative to the mid pivot link 34 and increase the inclination angle of the boom tube 46. Consequently, pivoting of the boom tube 46 pivots the timing link 50, which pivots the compression link 30. Extension of the linear actuator 56 expands the lower secondary articulation assembly 20 and expands the upper secondary extension assembly 22 from the collapsed position of FIG. 1, past the intermediate positions of FIGS. 2 and 3 to the expanded position of FIG. 4. Retraction of the linear actuator 56 collapses the lower secondary articulation assembly 20 and collapses the upper secondary extension assembly 22 from the expanded position of FIG. 4 back through FIGS. 3, then 2, to the collapsed position in FIG. 1.

The upper secondary extension assembly 22 also includes an inner boom tube 66 received for translation within the outer boom tube 46. The inner boom tube 66 is extendable relative to the outer boom tube 46 to extend and retract relative to the outer boom tube 46 to further extend the reach of the aerial lift assembly 10. The upper secondary extension assembly 22 also includes a linear actuator 68 (FIG. 2) connected to the outer boom tube 46 and the inner boom tube 66 for extending and retracting the inner boom tube 66.

The linear actuator 68 is also controlled by the controller 62. In order to manage the center of gravity of the aerial lift assembly 10, the controller 62 limits the extension of the linear actuator 68 when the lower secondary articulation assembly 20 and the upper secondary extension assembly 22 are collapsed in FIG. 1. Referring to FIG. 2, the inner boom tube 66 is retracted when the lower secondary articulation assembly 20 and the upper secondary extension assembly 22 are at an intermediate position whereby extension would move the center of gravity too far from the base pivot axis 28. However, once the compression link 30 is expanded divergently past the base pivot axis 28 in FIG. 3, the controller 62 permits extension of the linear actuator 68 to extend the inner boom tube 66 and consequently, the primary extension assembly 24.

The primary extension assembly 24 is another link assembly. The primary extension assembly 24 includes an upper pivot link 70 with a proximal end pivotally connected to the inner boom tube 66 at a pivotal connection 72. A second outer boom tube 74 is pivotally connected to a distal end of the pivot link 70 at a proximal end of the second outer boom tube 74 at a pivotal connection 76. The pivot link 70 and the second outer boom tube 74 are pivotal to collapse along the first outer boom tube 46 and the mid pivot link 34 as shown in FIG. 1, and to expand away from the first outer boom tube 46 as shown in FIGS. 2-4.

The primary extension assembly 24 also includes a coupler link 78 pivotally connected at a proximal end to the inner boom tube 66 at a pivotal connection 80. A lever 82 is pivotally connected to the pivot link 70 at a fulcrum pivotal connection 84. A proximal end of the lever 82 is pivotally connected to a distal end of the coupler link 78 at a pivotal connection 86. A proximal end of a second coupler link 88 is pivotally connected to a distal end of the lever 82 at a pivotal connection 90. A distal end of the second coupler link 88 is pivotally connected to the second outer boom tube 74 at a pivotal connection 92. The coupler links 78, 88 and the lever 82 cooperate to coordinate the expansion and collapse of the inner boom tube 66, the pivot link 70 and the second outer boom tube 74.

A linear actuator 94 has a cylinder body pivotally connected to the inner boom tube 66 at a pivotal connection 96. The linear actuator 94 has an extendable shaft that is pivotally connected to the pivot link 70 at a pivotal connection 98. The linear actuator 94 is controlled by the controller 62. Extension and retraction of the linear actuator 94 expands and retracts the second outer boom tube 74.

The primary extension assembly 24 includes an inner boom tube 100 received for translation within the second outer boom tube 74. The second inner boom tube 100 is extendable relative to the second outer boom tube 74 to extend and retract relative to the second outer boom tube 74 to further extend the reach of the aerial lift assembly 10. The primary extension assembly 24 also includes a linear actuator 102 (FIG. 2) connected to the second outer boom tube 74 and the second inner boom tube 100 for extending and retracting the second inner boom tube 100.

A jib link assembly 104 is pivotally connected to the distal end of the second inner boom tube 100. The jib link assembly 104 is pivotal relative to the second inner boom tube 100 for extension and retraction. The jib link assembly 104 supports the operator platform 64 for positioning the operator at an elevated height. The jib link assembly 104 cooperates with the second inner boom tube 100 and the platform 64 to maintain the platform 64 in an upright position.

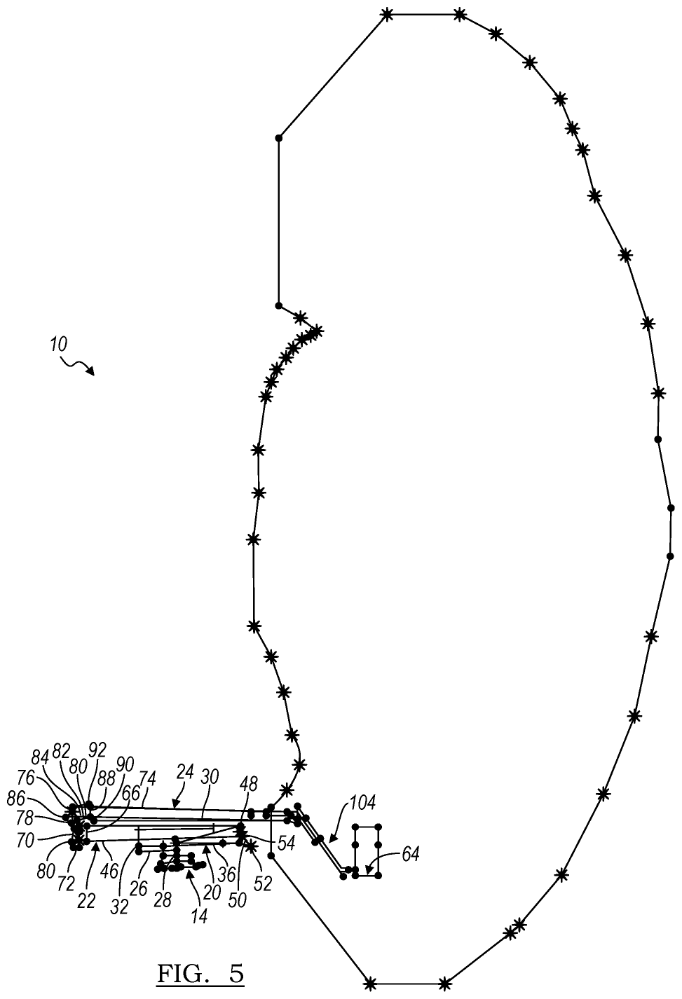

A reach area of the aerial lift assembly 10 is illustrated in FIG. 5. The aerial lift assembly 10 provides two extension assemblies, the primary extension assembly 24 and the upper secondary extension assembly 22 to provide two extendable ranges of translation for reaching significant heights. The aerial lift assembly 10 supports both extension assemblies 22, 24 upon a lower secondary articulation assembly 20 to further extend the range of the aerial lift assembly 10, while permitting compactness upon collapsing of the aerial lift assembly 10. The upper secondary extension and the lower secondary articulation cooperate to maintain the center of gravity of the aerial lift assembly 10 near the pivot axis of the 28 of the base 26 for stability of the frame 14. The aerial lift assembly 10 is able to reach heights that are greater than those attained with prior art counterbalance and frame lifts that are also adequately light and compact to fit behind, and be towed behind a truck.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An aerial lift assembly comprising:
a base to support the aerial lift assembly upon a support surface;
a first link assembly pivotally connected to the base to pivotally expand and collapse from the base;
a second link assembly pivotally connected to the first link assembly to pivotally expand and collapse from the first link assembly;
a first extendable boom assembly pivotally connected to the second link assembly to pivotally expand and collapse from the second link assembly, and to extend and retract from the second link assembly; and
an operator platform supported by the first extendable boom assembly; and
wherein the second link assembly comprises a second extendable boom assembly pivotally connected to the first link assembly to pivotally expand and collapse from the first link assembly, and to extend and retract from the first link assembly.

2. The aerial lift assembly of claim 1 further comprising:
a first actuator in cooperation with the second extendable boom assembly to extend and retract the second extendable boom assembly; and
a controller in communication with the first actuator, wherein the controller is programmed to limit extension of the second extendable boom assembly when the first link assembly is collapsed.

3. The aerial lift assembly of claim 2 wherein the controller is further programmed to limit extension of the second extendable boom assembly when the first link assembly is not expanded.

4. The aerial lift assembly of claim 3 wherein the controller is further programmed to permit extension of the second extendable boom assembly when the first link assembly is in an expanded position.

5. The aerial lift assembly of claim 2 further comprising a second actuator in cooperation with the second link assembly to expand and collapse the first link assembly, wherein the controller is in communication with the second actuator and is further programmed to expand the first link assembly prior to extending the second extendable boom assembly.

6. The aerial lift assembly of claim 1 further comprising a frame to be supported upon an underlying support surface, wherein the base is pivotally connected to the frame about an axis that is generally upright relative to the underlying support surface.

7. The aerial lift assembly of claim 6 wherein the first link assembly is pivotally connected to the base about an axis that is generally perpendicular to the pivot axis of the base, wherein the first link assembly pivot axis is offset from the base pivot axis such that the first link assembly converges toward the base pivot axis in a collapsed position of the first link assembly and the first link assembly is pivoted away from the base pivot axis in an expanded position of the first link assembly.

8. The aerial lift assembly of claim 7 further comprising a counterbalance supported upon the base spaced apart from the base pivot axis, wherein the first link assembly pivot axis is oriented between the counterbalance and the base pivot axis.

9. The aerial lift assembly of claim 8 wherein the first link assembly pivots away from the counterbalance toward the collapsed position.

10. The aerial lift assembly of claim 9 wherein the second link assembly pivots toward the counterbalance in the collapsed position.

11. The aerial lift assembly of claim 1 further comprising a third link assembly pivotally connected to the first extendable boom assembly, wherein the operator platform is connected to the third link assembly and spaced apart from the first extendable boom assembly.

12. The aerial lift assembly of claim 1 wherein the first link assembly comprises:
a compression link pivotally connected to the base;
a tension link pivotally connected to the base spaced apart from the pivotal connection of the compression link and the base; and
an intermediate link pivotally connected to the compression link, the tension link and the second link assembly.

13. The aerial lift assembly of claim 12 wherein the second link assembly further comprises:
a second compression link pivotally connected to the intermediate link;
a timing link pivotally connected to the first compression link and the second compression link; and
a linear actuator pivotally connected to the intermediate link and the second compression link.

14. An aerial lift assembly comprising:
a base to support the aerial lift assembly upon a support surface;
a first link assembly pivotally connected to the base to pivotally expand and collapse from the base;
a first extendable boom assembly pivotally connected to the first link assembly to pivotally expand and collapse from the first link assembly, and to extend and retract from the first link assembly;
a first actuator in cooperation with the first extendable boom assembly to extend and retract the first extendable boom assembly;
a second extendable boom assembly pivotally connected to the first extendable boom assembly to pivotally expand and collapse from the first extendable boom assembly, and to extend and retract from the first extendable boom assembly;
an operator platform supported by the second extendable boom assembly; and
a controller in communication with the first actuator, wherein the controller is programmed to limit extension of the first extendable boom assembly when the first link assembly is collapsed.

15. The aerial lift assembly of claim 14 wherein the controller is further programmed to limit extension of the first extendable boom assembly when the first link assembly is not expanded.

16. The aerial lift assembly of claim 15 wherein the controller is further programmed to permit extension of the first extendable boom assembly when the first link assembly is in an expanded position.

17. The aerial lift assembly of claim 14 further comprising a second actuator in cooperation with the first link assembly to expand and collapse the first link assembly, wherein the controller is in communication with the second actuator and is further programmed to expand the first link assembly prior to extending the first extendable boom assembly.

18. An aerial lift assembly comprising:
a frame to be supported upon an underlying support surface;
a base pivotally connected to the frame about an axis that is generally upright relative to the underlying support surface;
a first link assembly pivotally connected to the base about an axis that is generally perpendicular to the pivot axis of the base to pivotally expand and collapse from the base, wherein the first link assembly pivot axis is offset from the base pivot axis such that the first link assembly converges toward the base pivot axis in a collapsed position of the first link assembly and the first link assembly is pivoted away from the base pivot axis in an expanded position of the first link assembly;
a counterbalance supported upon the base spaced apart from the base pivot axis, wherein the first link assembly pivot axis is oriented between the counterbalance and the base pivot axis, and the first link assembly pivots away from the counterbalance toward the collapsed position;
a first actuator in cooperation with the second link assembly to expand and collapse the first link assembly;
a first extendable boom assembly pivotally connected to the first link assembly to pivotally expand and collapse from the first link assembly, and to extend and retract from the first link assembly, wherein the first extendable boom assembly pivots toward the counterbalance in the collapsed position;
a second actuator in cooperation with the first extendable boom assembly to extend and retract the first extendable boom assembly;
a second extendable boom assembly pivotally connected to the first extendable boom assembly to pivotally expand and collapse from the first extendable boom assembly, and to extend and retract from the first extendable boom assembly;
a second link assembly pivotally connected to the second extendable boom assembly;
an operator platform supported by the second link assembly to be spaced apart from the second extendable boom assembly; and
a controller in communication with the first actuator and the second actuator, wherein the controller is programmed to:
expand the first link assembly prior to extending the first extendable boom assembly,
limit extension of the first extendable boom assembly when the first link assembly is not expanded, and
permit extension of the first extendable boom assembly when the first link assembly is in the expanded position.

19. The aerial lift assembly of claim 18 wherein the first link assembly comprises:
a first compression link pivotally connected to the base;
a tension link pivotally connected to the base spaced apart from the pivotal connection of the first compression link and the base; and
an intermediate link pivotally connected to the compression link, the tension link and the first extendable boom assembly; and
wherein the first extendable boom assembly further comprises:
a second compression link pivotally connected to the intermediate link, and
a timing link pivotally connected to the first compression link and the second compression link; and
wherein the first actuator further comprises a linear actuator pivotally connected to the intermediate link and the second compression link.
